(19) United States
(12) Patent Application Publication
(10) Pub. No.: US 2006/0107544 A1
(43) Pub. Date: May 25, 2006

(54) Band saw having aiming device for linear cutting

(75) Inventor: Chin-Swan Wang, Taichung County (TW)

Correspondence Address: BROWDY AND NEIMARK, P.L.L.C.;624 NINTH STREET, NW, SUITE 300, WASHINGTON, DC, 20001-5303, US

(73) Assignee: OAV EQUIPMENT & TOOLS, INC., Taichung Hsien (TW)

(21) Appl. No.: 10/993,365

(22) Filed: Nov. 22, 2004

(51) Int. Cl. G01D 21/00

(52) U.S. Cl. 33/633

(57) ABSTRACT

A band saw includes a frame, which has a worktable and a saw blade extended through and movable relative to the worktable, and an aiming device, which has a casing moveably mounted in the frame, a light-emitting member mounted in the casing for emitting a light beam onto the worktable for linear cutting, and an adjustment unit for operation by the user to move the casing on the frame.

### BACKGROUND OF THE INVENTION

1. Field of the Invention

The present invention relates generally to a band saw and more particularly, to a band saw having an aiming device for linear cutting.

2. Description of the Related Art

When using a band saw to cut the workpiece through a linear cutting path, an aiming device may be used to align and calibrate the cutting position, enabling the workpiece to be moved straightly toward the saw blade for cutting. FIG. 7 shows a conventional band saw 90. The band saw 90 comprises an aiming device 91, which is installed in the outer shell of the band saw 90. The aiming device 91 comprises a casing 92 and an optical module 93. The optical module 93 is installed in the casing 92, comprising two laser emitters 94. The emitted laser beam of the laser emitters 94 and the cutting face of the saw blade 95 of the band saw 90 are on the same plane so that when the laser beam is projected onto the surface of the workpiece, the user can move the workpiece toward the cutting blade subject to the guide of the laser beam.

According to the aforesaid design, the aiming device 91 is directly fixedly fastened to the outer shell of the band saw 90 to have the emitted laser beam of the laser emitter 94 be aligned with the cutting face of the saw blade 95. When the installation position of the saw blade 95 changed due to a replacement or tension adjustment, the user must dismount the casing 92 and then install the casing 92 in the outer shell of the band saw 90 to match with the cutting face of the saw blade 95 again. This adjustment procedure is inconvenient and complicated.

### SUMMARY OF THE INVENTION

The present invention has been accomplished under the circumstances in view. It is the primary objective of the present invention to provide a band saw having an aiming device for linear cutting, which allows the user to conveniently adjust the position of the aiming device.

To achieve this objective of the present invention, the band saw comprises a frame and an aiming device. The frame includes a worktable and a saw blade extended through and movable relative to the worktable. The aiming device includes a casing moveably mounted in the frame, a light-emitting member mounted in the casing for emitting a light beam onto the worktable in alignment with the saw blade for linear cutting, and an adjustment unit mounted in the frame for moving the casing on the frame such that the light beam emitted by the light-emitting member can be adjusted to align with the saw blade.

### BRIEF DESCRIPTION OF THE DRAWINGS

FIG. 1 is a perspective view of a band saw according to a preferred embodiment of the present invention.

FIG. 2 is an enlarged perspective view of the band saw according to the preferred embodiment of the present invention, showing the structure of the aiming device.

FIG. 3 is an exploded view in an enlarged scale of a part of the band saw according to the preferred embodiment of the present invention, showing the structure of the aiming device.

FIG. 4 is a sectional view taken along line 4-4 of FIG. 2.

FIG. 5 is perspective view of a part of FIG. 1, showing one status of the aiming device.

FIG. 6 is similar to FIG. 5 but showing the aiming device adjusted.

FIG. 7 is a schematic drawing of a band saw having an aiming device according to the prior art.

### DETAILED DESCRIPTION OF THE INVENTION

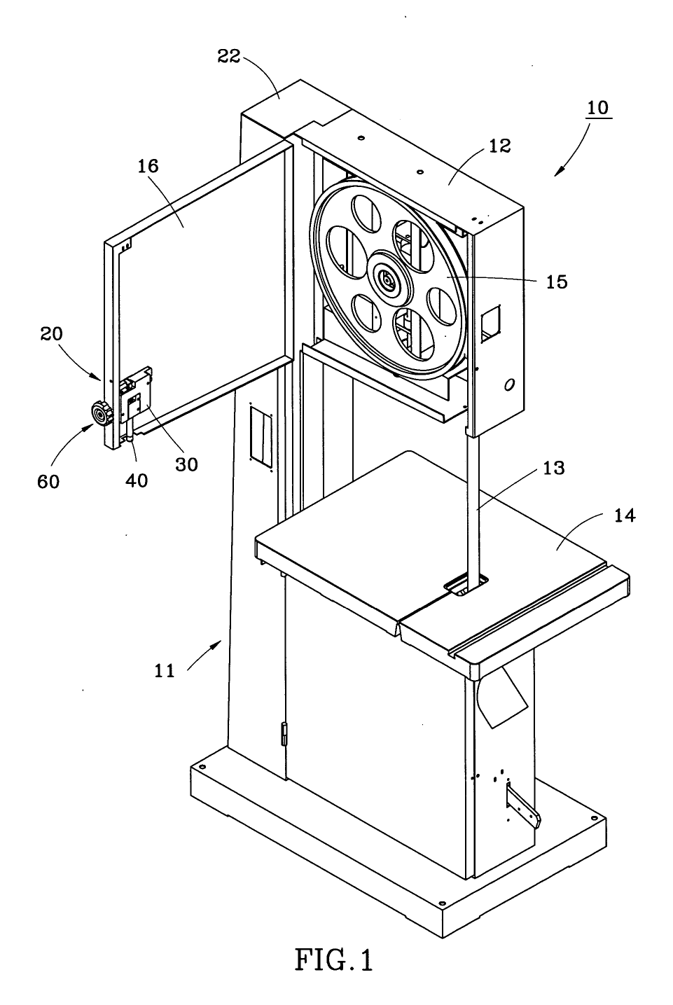

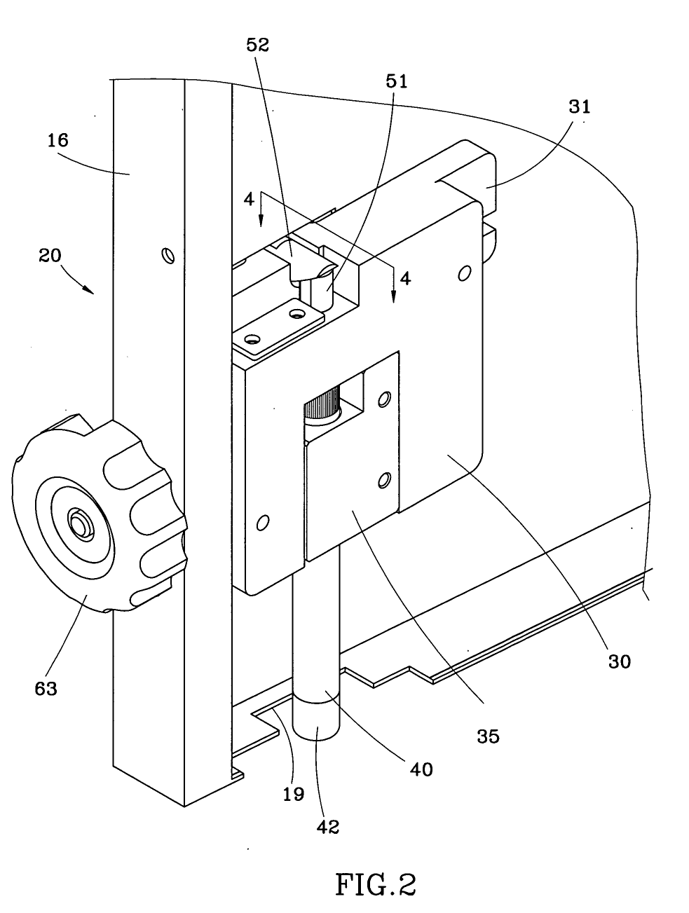

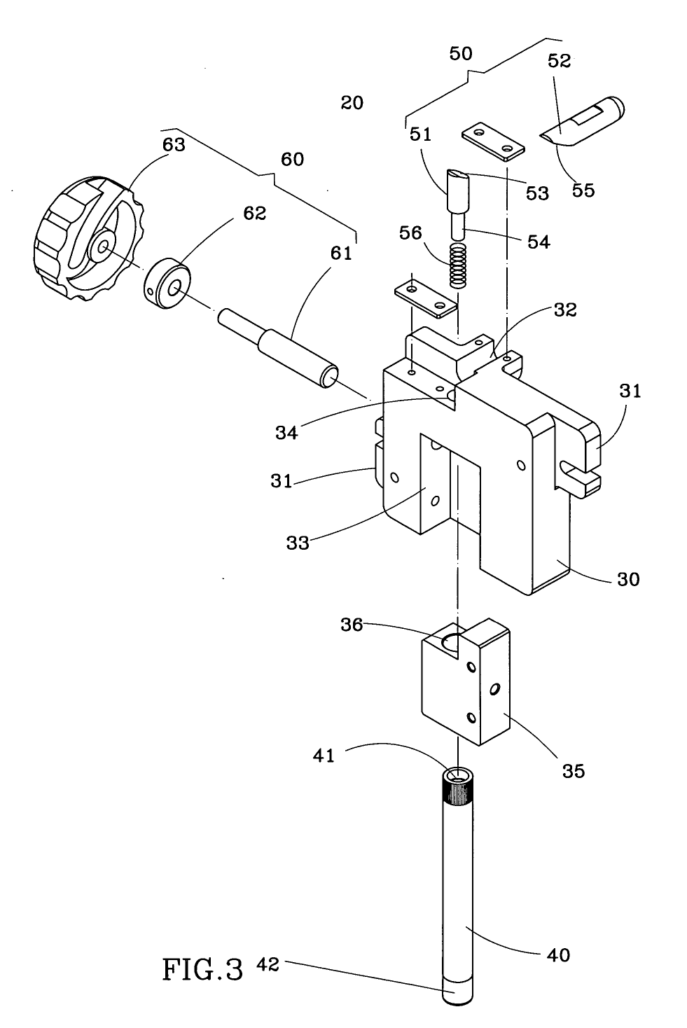

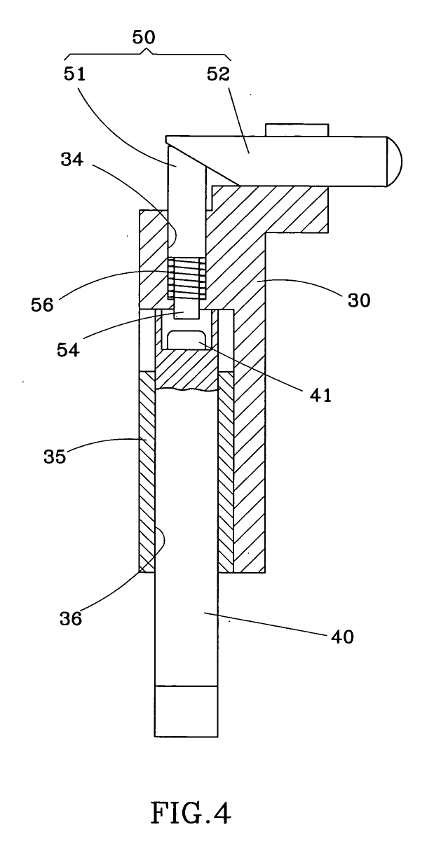

Referring to FIGS. 1-5, a band saw 10 provided by a preferred embodiment of the present invention is shown comprising a frame 11 and an aiming device 20.

The frame 11 comprises a base 22, a shell 12, a saw blade 13, a worktable 14, and a driving mechanism 15. The saw blade 13 extends through the shell 12 and the worktable 14. The driving mechanism 15 is controlled to move the saw blade 13 toward the bottom side of the worktable 14. The shell 12 has a cover 16. The cover 16 has two sliding slots 17 arranged in parallel to the cutting surface of the worktable 14, a through hole 18, and a bottom opening 19.

The aiming device 20 comprises a casing 30, a light-emitting member 40, a press button 50, and an adjustment unit 60. The casing 30 has two lugs 31 disposed at two opposite lateral sides, a guiding groove 32 disposed at the top, a recess 33 disposed at one side, and a stepped through hole 34 disposed in communication between the guiding groove 32 and the recess 34. Further, an insertion block 35 is inserted into the recess 34. The insertion block 35 has a through hole 36 in alignment with the stepped through hole 34.

The light-emitting member 40 is a laser light pen, having an on/off switch 41 at the top end and a lens assembly 42 at the bottom end. The on/off switch 41 is a press button switch. When switched on the on/off switch 41, the light-emitting member 40 emits a laser beam out of the lens assembly 42. The light-emitting member 40 is mounted in the through hole 36 of the insertion block 35, keeping the lens assembly 42 suspended below the casing 30.

The press button 50 comprises a first rod member 51, which is inserted through the stepped through hole 34 of the casing 30 and has one end terminating in a bevel face 53 and the other end terminating in an extension pin 54, a second rod member 52, which is slidably mounted in the guiding groove 32 and has a bevel face 55 pressed on the bevel face 53 of the first rod member 51, and a spring member 56 that is sleeved onto the extension pin 54 and supports the first rod member 51 in the stepped through hole 34. When pushing the second rod member 52 against the first rod member 51, the first rod member 51 will be forced downwards in the stepped through hole 34, thereby causing the extension pin 54 to press on the on/off switch 41, and therefore the light-emitting member 40 is switched on to emit a laser beam. When the second rod member 52 receives no pressure, the spring member 56 immediately pushes the first rod member 51 upwardly away from the on/off switch 41 of the light-emitting member 40 to return the first rod member 51, and therefore the on/off switch 41 of the light-emitting member 40 is switched off.

The casing 30 of the aiming device 20 is mounted on the inner side of the shell 16, keeping the second rod member 52 extended out of the through hole 18 and the lens assembly 42 of the light-emitting member 40 extended out of the bottom opening 19. Further, two locating elements 57 are respectively inserted through the sliding slots 17 and the lugs 31 to moveably secure the casing 30 to the shell 16, for enabling the casing 30 to be moved relative to the shell 16 between two distal ends of the sliding slots 17.

The adjustment unit 60 comprises a screw rod 61, a locating bearing 62, and a knob 63. The locating bearing 62 is affixed by its outer ring to the shell 16 corresponding in location to the casing 30. The screw rod 61 has a first end threaded into a screw hole (not shown) in the casing 30 and a second end inserted through the inner ring of the locating bearing 62 and extended out of the shell 16. The screw rod 61 is fitted to the inner ring of the locating bearing 62 such that the screw rod 61 is rotatable along with the inner ring of the bearing 62 relative to the shell 16 but cannot move axially. The knob 63 is fastened to the second end of the screw rod 61 outside the shell 16. Therefore, the user can operate the knob 63 to rotate the screw rod 61 so as to further move the casing 30 relative to the shell 16 along the sliding slots 17, thereby adjusting the light-emitting direction of the light-emitting member 40.

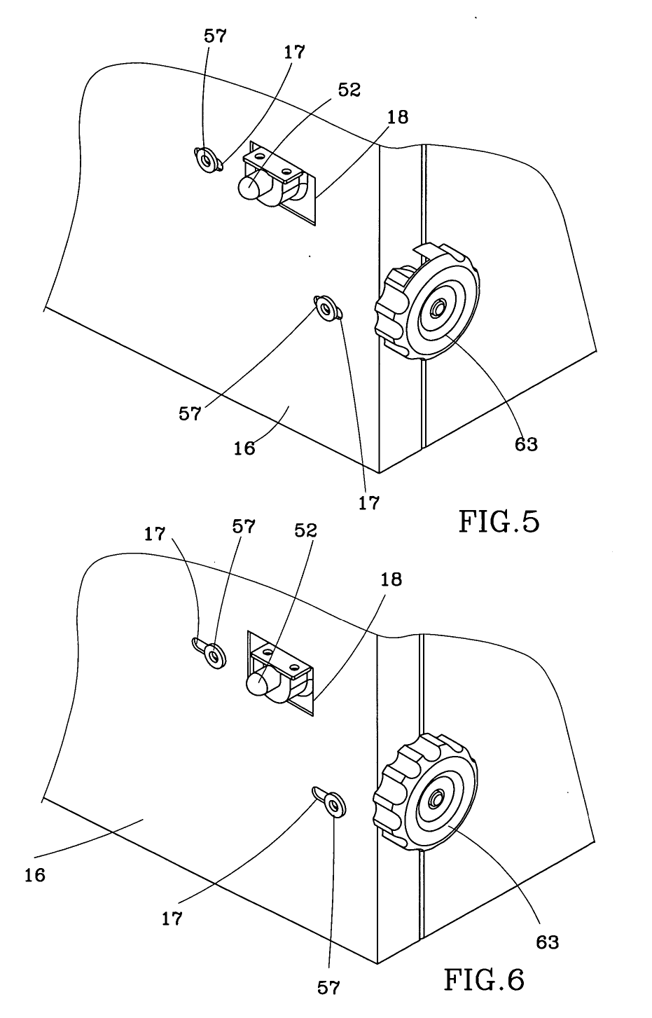

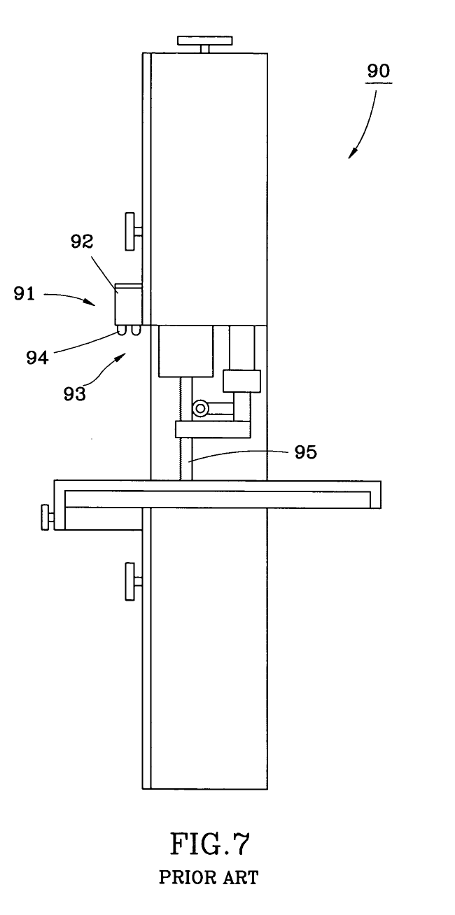

Referring to FIGS. 5 and 6, during sawing operation, the user can push the second rod member 52 of the press button 50 to force the first rod member 51 to switch on the on/off switch 41 of the light-emitting member 40, causing the light-emitting member 40 to emit a laser beam onto the worktable 14. At this time, the user can rotate the knob 63 to move the casing 30 to the position where the laser beam of the light-emitting member 40 is in alignment with the cutting face of the saw blade 13. Thereafter, the user can use the aiming device 20 to have the emitted laser beam be projected onto the surface of the workpiece, keeping the predetermined cutting path of the workpiece in alignment with the laser beam. Thus, the saw blade 13 fits the cutting path of the workpiece, and the user can then start the cutting operation. If the position of the saw blade 13 relative to the worktable 14 is adjusted, the user can directly use the knob 63 of the adjustment unit 60 to move the casing 30 to the position where the emitted laser beam of the light-emitting member 40 is again in alignment with the cutting face of the saw blade 13.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A band saw comprising:
a frame having a worktable and a saw blade extended through said worktable and movable relative to said worktable; and
an aiming device having a casing movably mounted in said frame, a light-emitting member mounted in said casing for emitting a light beam onto said worktable, and an adjustment unit for moving said casing on said frame.

2. The band saw as claimed in claim 1, wherein said frame comprises two sliding slots; said casing comprises two lugs respectively corresponding to said sliding slots and two locating elements respectively inserted through the sliding slots of said frame and coupled to the lugs of said casing for guiding movement of said casing relative to said frame along said sliding slots; said adjustment unit comprises a screw rod threaded into casing for rotation by the user to move said casing along said sliding slots.

3. The band saw as claimed in claim 1, wherein said aiming device further comprises a press button mounted in said casing for pressing by the user to switch on/off said light-emitting member.

4. The band saw as claimed in claim 3, wherein said light-emitting member comprises an on/off press button switch; said press button comprises a first rod member slidably mounted in said casing, and a second rod member disposed in contact with one end of said first rod member for pushing by the user to force said first rod member to press the on/off press button switch of said light-emitting member.

5. The band saw as claimed in claim 4, wherein said frame comprises a through hole through which said second rod member of said press button extends to the outside of said frame.

6. The band saw as claimed in claim 1, wherein said casing comprises a recess and an insertion block mounted in said recess for accommodating said light-emitting member.
